(19) United States
(12) Patent Application Publication
(10) Pub. No.: US 2026/0168247 A1
(43) Pub. Date: Jun. 18, 2026

(54) SHINGLE WITH IMPROVED TEAR STRENGTH

(71) Applicant: Owens Corning Intellectual Capital, LLC, Toledo, OH (US)

(72) Inventors: Samuel Ares, Loveland, OH (US); Ganesh Latta, Galena, OH (US); William Edwin Smith, Pataskala, OH (US)

(21) Appl. No.: 19/355,194

(22) Filed: Oct. 10, 2025

Related U.S. Application Data
(60) Provisional application No. 63/734,827, filed on Dec. 17, 2024.

(51) Int. Cl. E04D 1/20; C08L 95/00; C09D 195/00

(52) U.S. Cl. CPC E04D 1/20; C09D 195/00; C08L 95/00; C08L 2555/34; C08L 2555/70; C08L 2555/84

(57) ABSTRACT

A roofing shingle comprises a base material and a shingle coating composition applied to at least one side of the base material. The shingle coating composition comprises an asphalt base composition and greater than or equal to about 5 wt. % of a filler, based on a total weight of the shingle coating composition. The filler has a Mohs hardness of greater than about 3. The asphalt base composition comprises non-oxidized or partially oxidized asphalt; optionally, at least one polymer additive; from 6 wt. % to less than 20 wt. % ground tire rubber, based on a total weight of the asphalt base composition; and wax, in an amount up to about 6 wt. %, based on a total weight of the asphalt base composition.

### CROSS-REFERENCE TO RELATED APPLICATIONS

This application claims priority to and all benefit of U.S. Provisional Patent Application No. 63/734,827, filed on Dec. 17, 2024, the entire disclosure of which is fully incorporated herein by reference.

### FIELD

The inventive concepts generally relate to roofing shingles and, in particular, to roofing shingles having improved tear strength.

### BACKGROUND

Asphalt-based roofing materials, such as roofing shingles, roll roofing, and commercial roofing, are installed on the roofs of buildings to provide protection from the elements, and to give the roof an aesthetically pleasing look. Typically, a roofing shingle is constructed of a substrate such as a glass fiber mat or an organic felt, an asphalt coating on the substrate, and a surface layer of granules or other surfacing minerals embedded in the asphalt coating.

Asphalt-based roofing shingles are generally made by mixing asphalt with an inorganic filler material to make a filled asphalt coating. The roofing substrate is then coated on each side and saturated with the filled asphalt coating, forming an asphalt-coated substrate that may subsequently be coated with a layer of granules, and other optional coating materials to form a roofing shingles.

Although filler material is less expensive than the asphalt itself, the filler can adversely impact various properties of the asphalt coating material and the final shingle. Accordingly, there remains a need for alternative shingle coating compositions that lead to improved shingle properties.

### SUMMARY

The general inventive concepts relate to a shingle coating composition that includes an asphalt base composition including non-oxidized or partially oxidized asphalt, ground tire rubber (GTR), and a wax and a filler having a Mohs hardness of greater than about 3. Shingles including the shingle coating composition exhibit improved shingle tear performance as compared to an otherwise identical shingle formed from a shingle coating composition not including the GTR.

In a first aspect of the present disclosure, a roofing shingle comprises a base material and a shingle coating composition applied to at least one side of the base material. The shingle coating composition comprises an asphalt base composition and greater than or equal to about 5 wt. % of a filler, based on a total weight of the shingle coating composition. The filler has a Mohs hardness of greater than about 3. The asphalt base composition comprises non-oxidized or partially oxidized asphalt; optionally, at least one polymer additive; from 6 wt. % to less than 20 wt. % ground tire rubber, based on a total weight of the asphalt base composition; and wax, in an amount up to about 6 wt. %, based on a total weight of the asphalt base composition.

In a second aspect, a roofing shingle comprises the roofing shingle of the first aspect, wherein the filler is selected from the group consisting of dolomite, silica, granite, fly ash, wollastonite, recycled asphalt shingles, reclaimed filler from asphalt shingles, and combinations thereof.

In a third aspect, a roofing shingle comprises the roofing shingle of any previous aspect, wherein the wax is a Fisher-Tropsch wax having a crystallinity of from about 50 to about 90%.

In a fourth aspect, a roofing shingle comprises the roofing shingle of any previous aspect, wherein the at least one polymer additive comprises a linear copolymer, a radial copolymer, or a blend thereof.

In a fifth aspect, a roofing shingle comprises the roofing shingle of any previous aspect, wherein the at least one polymer additive is selected from the group consisting of atactic polypropylene (APP), isotactic polypropylene (IPP), styrene-butadiene rubber (SBS), polychloroprene; polynorbornene; chloroprene rubber (CR), natural and reclaimed rubbers, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), vinylacetate/polyethylene (EVA), ethylene-methylacrylate copolymers (EMA), copolymers of olefins and unsaturated carboxylic esters, polyolefinic copolymers, polyolefins, copolymers of ethylene and esters of acrylic acid or methacrylic acid or maleic anhydride, copolymers and terpolymers of ethylene and glycidyl methacrylate, ethylene/propylene copolymers, and rubber.

In a sixth aspect, a roofing shingle comprises the roofing shingle of any previous aspect, wherein the at least one polymer additive comprises SBS.

In a seventh aspect, a roofing shingle comprises the roofing shingle of any previous aspect, wherein the at least one polymer additive is present in the asphalt base composition in an amount of from about 1 wt. % to about 3 wt. %.

In an eighth aspect, a roofing shingle comprises the roofing shingle of any previous aspect, wherein the wax is present in the asphalt base composition in an amount of from about 2 wt. % to about 6 wt. %.

In a ninth aspect, a roofing shingle comprises the roofing shingle of any previous aspect, wherein the roofing shingle exhibits a tear resistance of at least about 1600 grams-force.

In a tenth aspect, a roofing shingle comprises the roofing shingle of any previous aspect, wherein the asphalt base composition exhibits a ring and ball softening point of from about 190° F. to about 320° F.

In an eleventh aspect, a roofing shingle comprises the roofing shingle of any previous aspect, wherein the asphalt base composition exhibits a viscosity of from about 250 mPa·s to about 2500 mPa·s at 350° F. when measured according to ASTM D4402.

According to a twelfth aspect, a shingle coating composition comprises an asphalt base composition and greater than or equal to about 5 wt. % of a filler having a Mohs hardness of greater than about 3, based on a total weight of the shingle coating composition. The asphalt base composition comprises non-oxidized or partially oxidized asphalt; at least one polymer additive; from 5 wt. % to less than 12 wt. % ground tire rubber based on a total weight of the shingle coating composition; and wax, in an amount of up to about 6 wt. % based on a total weight of the shingle coating composition. The shingle coating composition exhibits a penetration value at 25° C. of at least about 15 dmm and a ring and ball softening point of from about 190° F. to about 320° F.

In a thirteenth aspect, a shingle coating composition comprises the shingle coating composition of the twelfth aspect, wherein the filler is selected from the group consisting of dolomite, silica, granite, fly ash, wollastonite, recycled asphalt shingles, reclaimed filler from asphalt shingles, and combinations thereof.

In a fourteenth aspect, a shingle coating composition comprises the shingle coating composition of the twelfth or thirteenth aspects, wherein the wax is a Fisher-Tropsch wax having a crystallinity of from about 50 to about 90%.

In a fifteenth aspect, a shingle coating composition comprises the shingle coating composition of any one of the twelfth through fourteenth aspects, wherein the at least one polymer additive comprises a linear copolymer, a radial copolymer, or a blend thereof.

In a sixteenth aspect, a shingle coating composition comprises the shingle coating composition of any one of the twelfth through fifteenth aspects, wherein the at least one polymer additive is styrene-butadiene rubber (SBS).

In a seventeenth aspect, a shingle coating composition comprises the shingle coating composition of any one of the twelfth through sixteenth aspects, wherein the at least one polymer additive is present in the asphalt base composition in an amount of from about 1 wt. % to about 3 wt. %.

In an eighteenth aspect, a shingle coating composition comprises the shingle coating composition of any one of the twelfth through seventeenth aspects, wherein the wax is present in the asphalt base composition in an amount of from about 2 wt. % to about 6 wt. %.

According to a nineteenth aspect, a roofing shingle comprises a base material and a shingle coating composition applied to at least one side of the base material. The shingle coating composition comprises an asphalt base composition and greater than or equal to about 5 wt. % of a filler, based on a total weight of the shingle coating composition. The filler has a Mohs hardness of greater than about 3. The asphalt base composition comprises non-oxidized or partially oxidized asphalt; from 6 wt. % to less than 20 wt. % ground tire rubber, based on a total weight of the asphalt base composition; and wax, in an amount of up to about 6 wt. %, based on a total weight of the asphalt base composition.

In a twentieth aspect, a roofing shingle comprises the roofing shingle of the nineteenth aspect, wherein the filler is selected from the group consisting of dolomite, silica, granite, fly ash, wollastonite, recycled asphalt shingles, reclaimed filler from asphalt shingles, and combinations thereof.

In a twenty-first aspect, a roofing shingle comprises the roofing shingle of the nineteenth or twentieth aspects, wherein the wax is a Fisher-Tropsch wax having a crystallinity of from about 50 to about 90%.

In a twenty-second aspect, a roofing shingle comprises the roofing shingle of any one of the nineteenth through twenty-first aspects, wherein the wax is present in the asphalt base composition in an amount of from about 2 wt. % to about 6 wt. %.

In a twenty-third aspect, a roofing shingle comprises the roofing shingle of any one of the nineteenth through twenty-second aspects, wherein the roofing shingle exhibits a tear resistance of at least about 1600 grams-force.

In a twenty-fourth aspect, a roofing shingle comprises the roofing shingle of any one of the nineteenth through twenty-third aspects, wherein the asphalt base composition exhibits a ring and ball softening point of from about 190° F. to about 235° F.

In a twenty-fifth aspect, a roofing shingle comprises the roofing shingle of any one of the nineteenth through twenty-fourth aspects, wherein the asphalt base composition exhibits a viscosity of from about 250 mPa·s to about 1500 mPa·s at 350° F. when measured according to ASTM D4402.

According to a twenty-sixth aspect, a shingle coating composition comprises an asphalt base composition and greater than or equal to about 5 wt. % of a filler having a Mohs hardness of greater than about 3, based on a total weight of the shingle coating composition. The asphalt base composition comprises non-oxidized or partially oxidized asphalt; from 6 wt. % to less than 20 wt. % ground tire rubber based on a total weight of the asphalt base composition; and wax, in an amount of up to about 6 wt. %, based on a total weight of the asphalt base composition. The shingle coating composition exhibits penetration value at 25° C. of at least about 15 dmm and a ring and ball softening point of from about 190° F. to about 235° F.

In a twenty-seventh aspect, a shingle coating composition comprises the shingle coating composition of the twenty-sixth aspect, wherein the filler is selected from the group consisting of dolomite, silica, granite, fly ash, wollastonite, recycled asphalt shingles, reclaimed filler from asphalt shingles, and combinations thereof.

In a twenty-eighth aspect, a shingle coating composition comprises the shingle coating composition of the twenty-sixth or twenty-seventh aspect, wherein the wax is a Fisher-Tropsch wax having a crystallinity of from about 50 to about 90%.

In a twenty-ninth aspect, a shingle coating composition comprises the shingle coating composition of any of the twenty-sixth through twenty-eighth aspects, wherein the wax is present in the shingle coating composition in an amount of from about 2 wt. % to about 6 wt. %.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts relate to a shingle coating composition that includes an asphalt base composition including non-oxidized or partially oxidized asphalt, recycled rubber, and a wax, and a filler having a Mohs hardness of greater than about 3. Roofing shingles including the shingle coating composition exhibit improved shingle tear performance as compared to an otherwise identical roofing shingle formed from a shingle coating composition not including the recycled rubber component.

It was surprisingly discovered that a roofing shingle having improved properties (e.g., tear strength) could be made by including recycled rubber (i.e., ground tire rubber (“GTR”) or crumb rubber) and wax in the asphalt base composition, despite the use of a filler having a Mohs hardness of greater than about 3. Furthermore, use of the shingle coating composition disclosed herein enables a roofing shingle to be constructed with improved tear strength, while including recycled rubber materials.

### Asphalt Base Composition

The asphalt base compositions disclosed herein include recycled or reclaimed rubber, a wax, and non-oxidized or partially oxidized asphalt. The asphalt in the asphalt base composition is unfilled, but this base composition may be further blended with at least about 5 wt. % of a filler to provide a shingle coating composition that can provide improved shingle properties, such as tear resistance.

As introduced above, the asphalt base composition includes recycled or reclaimed rubber. The rubber may be recycled or recovered from automotive and truck tires and ground into smaller pieces or particles. Recycled rubber processed in this way may be referred to as ground tire rubber (“GTR”) or crumb rubber. Although the disclosure refers primarily to GTR, it should be appreciated that any form of recycled rubber may alternatively be used and within the scope of the inventive concepts.

The GTR included in the asphalt base composition may have a particle size of from about 18 mesh (about 1,000 microns) to about 100 mesh (about 150 microns), as measured in accordance with ASTM D5603-01. For example, the GTR may have a particle size of from about 18 mesh (about 1,000 microns) to about 32 mesh (about 568 microns), from about 40 mesh (about 400 microns) to about 80 mesh (about 177 microns), or from about 80 mesh (about 177 microns) to about 100 mesh (about 150 microns), including all endpoints and subranges therebetween. In aspects, the GTR has an average particle size of from about 155 microns to about 1300 microns, and can be, for example, about 155 microns, about 500 microns, or about 1300 microns. The particle size of the GTR can impact, for example, the softening point, the penetration value, and the viscosity of the asphalt coating composition.

The GTR may be included in the asphalt base composition in an amount of less than about 20 wt. %. Amounts greater than or equal to about 20 wt. % GTR in the asphalt base composition raise the softening point and viscosity of the asphalt base composition to values that render the asphalt composition unsuitable for use in roofing applications. As such, the GTR may be included in the asphalt base composition in an amount of from about 5 wt. % to less than about 20 wt. %, including, for example, from about 6 wt. % to less than about 20 wt. %, from about 10 wt. % to less than about 20 wt. %, from about 14 wt. % to less than about 20 wt. %, from about 5 wt. % to about 19 wt. %, from about 6 wt. % to about 19 wt. %, from about 10 wt. % to about 19 wt. %, from about 14 wt. % to about 19 wt. %, from about 5 wt. % to about 18 wt. %, from about 6 wt. % to about 18 wt. %, from about 10 wt. % to about 18 wt. %, from about 14 wt. % to about 18 wt. %, from about 5 wt. % to about 17 wt. %, from about 6 wt. % to about 17 wt. %, from about 10 wt. % to about 17 wt. %, from about 14 wt. % to about 17 wt. %, from about 5 wt. % to about 16 wt. %, from about 6 wt. % to about 16 wt. %, from about 10 wt. % to about 16 wt. %, from about 14 wt. % to about 16 wt. %, from about 5 wt. % to about 15 wt. %, from about 6 wt. % to about 15 wt. %, from about 10 wt. % to about 15 wt. %, from about 14 wt. % to about 15 wt. %, from about 5 wt. % to about 12 wt. %, from about 6 wt. % to about 12 wt. %, or from about 10 wt. % to about 12 wt. %, based on the total weight of solids in the asphalt base composition, including all endpoints and subranges therebetween. In exemplary aspects, the GTR may be included in the asphalt base composition in an amount of from about 5 wt. % to about 12 wt. % or from about 6 wt. % to about 19 wt. %, based on the total weight of solids in the asphalt base composition. In exemplary aspects, the GTR is included in an amount of about 6 wt. %, about 10 wt. %, or about 14 wt. % based on the weight of the total amount of solids in the asphalt base composition.

The asphalt base composition further includes a wax. Suitable waxes can include, by way of example and not limitation, oligomerized polyolefins (e.g., polypropylene waxes and polyethylene waxes), ethylene bis(stearamide) (EBS) waxes, Fischer-Tropsch waxes (e.g., SASOBIT™), polyethylene terephthalate (PET) waxes, acrylic waxes, and combinations thereof. The waxes may be recycled, reclaimed, or virgin waxes. For example, the wax may be a recycled, reclaimed, or virgin polyethylene or polypropylene wax. Other recycled waxes, such as recycled nylon and acrylic may be used in one or more aspects.

The wax may be characterized according to its crystallinity, and the wax included in the asphalt base composition may have a crystallinity of from about 50% to about 90%, as measured in accordance with ASTM E794-24. For example, the wax may have a crystallinity of from about 50% to about 90%, from about 50% to about 85%, from about 50% to about 80%, from about 50% to about 75%, from about 50% to about 70%, from about 55% to about 90%, from about 55% to about 85%, from about 55% to about 80%, from about 55% to about 75%, from about 55% to about 70%, from about 60% to about 90%, from about 60% to about 85%, from about 60% to about 80%, from about 60% to about 75%, from about 60% to about 70%, from about 65% to about 90%, from about 65% to about 85%, from about 65% to about 80%, from about 65% to about 75%, from about 65% to about 70%, from about 70% to about 90%, from about 70% to about 85%, from about 70% to about 80%, from about 70% to about 75%, from about 75% to about 90%, from about 75% to about 85%, or from about 75% to about 80%, including all endpoints and subranges therebetween.

The wax may be included in the asphalt base composition in an amount of up to about 6 wt. %, based on the weight of the total amount of solids in the asphalt base composition. For example, the wax may be included in the asphalt base composition in an amount of from greater than 0 wt. % to about 6 wt. %, from about 1 wt. % to about 6 wt. %, from about 2 wt. % to about 6 wt. %, from about 3 wt. % to about 6 wt. %, from about 4 wt. % to about 6 wt. %, from greater than 0 wt. % to about 5 wt. %, from about 1 wt. % to about 5 wt. %, from about 2 wt. % to about 5 wt. %, from about 3 wt. % to about 5 wt. %, from about 4 wt. % to about 5 wt. %, from greater than 0 wt. % to about 4 wt. %, from about 1 wt. % to about 4 wt. %, from about 2 wt. % to about 4 wt. %, from about 3 wt. % to about 4 wt. %, from greater than 0 wt. % to about 4 wt. %, from about 1 wt. % to about 4 wt. %, from about 2 wt. % to about 4 wt. %, from greater than 0 wt. % to about 2 wt. %, or from about 1 wt. % to about 2 wt. %, based on the weight of the total amount of solids in the asphalt base composition, including all endpoints and subranges therebetween. In some aspects, the asphalt base composition includes from about 2 wt. % to about 6 wt. % or from about 3 wt. % to about 6 wt. % of the wax, based on the weight of the total amount of solids in the asphalt base composition.

The balance of the asphalt base composition comprises an asphalt material, or base asphalt, which is understood to mean any asphalt material composed of one or more asphalt bases. As used herein, the term “asphalt” is meant to include any bituminous materials produced from petroleum refining, including residua from atmospheric distillation, from vacuum distillation, from solvent de-asphalting units, and from recycled asphalt streams, such as re-refined motor oil bottoms. The asphalt may include various types or grades of asphalt, including flux, paving grade asphalt blends, propane washed asphalt, and/or blends thereof. By “paving grade asphalt,” as used herein, is meant a performance grade asphalt according to AASH20 17320-17 that has a softening point within the range of about 60° F. to about 130° F. and a penetration value of at least about 25 dmm. Exemplary paving-grade asphalts are those which meet the PG 64-22 specifications (AASHTO M320). PG 64-22 is the most common paving specification in the United States. Paving asphalts were previously graded by viscosity and a common asphalt that is similar to the PG 64-22 grade asphalt and also usable in this method, is the old AC20 grade asphalt (ASTM D 3381). Other examples of suitable paving-grade asphalts include PG 67-22, PG 70-22, PG 58-22, PG 58-28, PG 58-22, PG 70-16, PG 70-10, PG 67-10, pen grade 40/50, pen grade 60/70, pen grade 85/100, pen grade 120/150, AR4000, AR8000, and AC/30 grade.

Paving grade asphalts are distinct from conventional “coating grade” asphalt, as defined by ASTM D 3462-16: a softening point minimum of from 190° F. (88° C.) to 235° F. (113° C.) and a penetration at 77° F. (25° C.) minimum of 15 decimillimeter (dmm).

Mixtures of different asphalts can also be used. Some aspects disclosed herein can also be used with natural bitumen, such as the products extracted from oil sands in Alberta or asphalts derived from oil sands by various refinery processes.

The base asphalt may be partially oxidized asphalt, non-oxidized asphalt, and/or blends thereof. In particular, the base asphalt is no greater than 50% oxidized, such as no greater than 30% oxidized, no greater than 20% oxidized, no greater than 10% oxidized, no greater than 5% oxidized, and no greater than 1% oxidized. Preferably, the base asphalt is not oxidized or otherwise blown.

In various aspects herein, the base asphalt is included in the asphalt base composition in an amount of from about 10 wt. % to about 92 wt. %, based on the weight of the total amount of solids in the asphalt base composition. For example, the asphalt base composition may include from about 10 wt. % to about 92 wt. %, from about 20 wt. % to about 92 wt. %, from about 30 wt. % to about 92 wt. %, from about 40 wt. % to about 92 wt. %, from about 50 wt. % to about 92 wt. %, from about 60 wt. % to about 92 wt. %, from about 10 wt. % to about 91 wt. %, from about 20 wt. % to about 91 wt. %, from about 30 wt. % to about 91 wt. %, from about 40 wt. % to about 91 wt. %, from about 50 wt. % to about 91 wt. %, from about 60 wt. % to about 91 wt. %, from about 10 wt. % to about 80 wt. %, from about 20 wt. % to about 80 wt. %, from about 30 wt. % to about 80 wt. %, from about 40 wt. % to about 80 wt. %, from about 50 wt. % to about 80 wt. %, from about 60 wt. % to about 80 wt. %, from about 10 wt. % to about 70 wt. %, from about 20 wt. % to about 70 wt. %, from about 30 wt. % to about 70 wt. %, from about 40 wt. % to about 70 wt. %, from about 50 wt. % to about 70 wt. %, from about 60 wt. % to about 70 wt. %, from about 10 wt. % to about 60 wt. %, from about 20 wt. % to about 60 wt. %, from about 30 wt. % to about 60 wt. %, from about 40 wt. % to about 60 wt. %, from about 50 wt. % to about 60 wt. %, from about 10 wt. % to about 50 wt. %, from about 20 wt. % to about 50 wt. %, from about 30 wt. % to about 50 wt. %, or from about 40 wt. % to about 50 wt. % of the base asphalt, including all endpoints and subranges therebetween, based on the weight of the total amount of solids in the asphalt base composition. In some aspects, the asphalt base composition includes from about 75 wt. % to about 91 wt. % or from about 79 wt. % to about 92 wt. % of the base asphalt, based on the weight of the total amount of solids in the asphalt base composition.

The asphalt base composition may optionally further comprise at least one polymer additive. The polymer additive may comprise an elastomeric radial or linear polymer. The polymer additive may comprise a copolymer such as a linear or radial copolymer. In some aspects, the polymer additive comprises one or more of atactic polypropylene (APP), isotactic polypropylene (IPP), styrene-butadiene-styrene rubber (SBS), polychloroprene; polynorbornène; chloroprene rubber (CR), butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, vinylacetate/polyethylene (EVA), ethylene-methylacrylate copolymers (EMA), copolymers of olefins and unsaturated carboxylic esters such as ethylene-butylacrylates (EBA), polyolefinic copolymers, polyolefins such as polybutenes (PB), copolymers of ethylene and esters of acrylic acid or methacrylic acid or maleic anhydride, copolymers and terpolymers of ethylene and glycidyl methacrylate, ethylene/propylene copolymers, rubber, and mixtures thereof. In other aspects, the polymer additive comprises a linear polymer or a combination of linear and radial polymers. Examples of polymer modifiers are also disclosed in U.S. Pat. No. 4,738,884 to Algrim et al., U.S. Pat. No. 3,770,559 to Jackson, and 11,028,591 to LaTorre et al., the contents of which are incorporated herein by reference in their entirety. In some exemplary aspects, the asphalt is modified with styrene-butadiene-styrene rubber (SBS).

The polymer additive may be included in the asphalt base composition in an amount from about 1.0 wt. % to about 3.0 wt. %, based on the weight of the total amount of solids in the asphalt base composition. The polymer additive may be included in an amount from about 1.0 to about 3.0 wt. %, from about 1.5 to about 3.0 wt. %, from about 2.0 to about 3.0 wt. %, from about 2.5 to about 3.0 wt. %, from about 1.0 to about 2.5 wt. %, from about 1.5 to about 2.5 wt. %, from about 2.0 to about 2.5 wt. %, from about 1.0 to about 2.0 wt. %, from about 1.5 to about 2.0 wt. %, or from about 1.0 to about 1.5 wt. %, based on the weight of the total amount of solids in the asphalt base composition. If the polymer additive is added in an amount of greater than about 3.0 wt. %, the amount of GTR will need to be reduced to achieve a viscosity that is suitable for processing and roofing applications.

The asphalt base composition of various aspects disclosed herein exhibits a viscosity of from about 250 mPa·s to about 2,500 mPa·s at 350° F. and as measured in accordance with ASTM D4402. Viscosities of greater than about 2,500 mPa's present difficulties during manufacturing. For example, the asphalt base composition may have a viscosity of from about 250 mPa·s to about 2500 mPa·s, from about 275 mPa·s to about 2500 mPa·s, from about 300 mPa·s to about 2500 mPa·s, from about 325 mPa·s to about 2500 mPa·s, from about 350 mPa·s to about 2500 mPa·s, from about 375 mPa·s to about 2500 mPa·s, from about 400 mPa·s to about 2500 mPa·s, from about 450 mPa·s to about 2500 mPa·s, from about 500 mPa·s to about 2500 mPa·s, from about 550 mPa·s to about 2500 mPa·s, from about 600 mPa·s to about 2500 mPa·s, from about 650 mPa·s to about 2500 mPa·s, from about 700 mPa·s to about 2500 mPa·s, from about 750 mPa·s to about 2500 mPa·s, from about 250 mPa·s to about 2000 mPa·s, from about 275 mPa·s to about 2000 mPa·s, from about 300 mPa·s to about 2000 mPa·s, from about 325 mPa·s to about 2000 mPa·s, from about 350 mPa·s to about 2000 mPa·s, from about 375 mPa·s to about 2000 mPa·s, from about 400 mPa·s to about 2000 mPa·s, from about 450 mPa·s to about 2000 mPa·s, from about 500 mPa·s to about 2000 mPa·s, from about 550 mPa·s to about 2000 mPa·s, from about 600 mPa·s to about 2000 mPa·s, from about 650 mPa·s to about 2000 mPa·s, from about 700 mPa·s to about 2000 mPa·s, from about 750 mPa·s to about 2000 mPa·s, from about 250 mPa·s to about 1750 mPa·s, from about 275 mPa·s to about 1750 mPa·s, from about 300 mPa·s to about 1750 mPa·s, from about 325 mPa·s to about 1750 mPa·s, from about 350 mPa·s to about 1750 mPa·s, from about 375 mPa·s to about 1750 mPa·s, from about 400 mPa·s to about 1750 mPa·s, from about 450 mPa·s to about 1750 mPa·s, from about 500 mPa·s to about 1750 mPa·s, from about 550 mPa·s to about 1750 mPa·s, from about 600 mPa·s to about 1750 mPa·s, from about 650 mPa·s to about 1750 mPa·s, from about 700 mPa·s to about 1750 mPa·s, from about 750 mPa·s to about 1750 mPa·s, from about 250 mPa·s to about 1650 mPa·s, from about 275 mPa·s to about 1650 mPa·s, from about 300 mPa·s to about 1650 mPa·s, from about 325 mPa·s to about 1650 mPa·s, from about 350 mPa·s to about 1650 mPa·s, from about 375 mPa·s to about 1650 mPa·s, from about 400 mPa·s to about 1650 mPa·s, from about 450 mPa·s to about 1650 mPa·s, from about 500 mPa·s to about 1650 mPa·s, from about 550 mPa·s to about 1650 mPa·s, from about 600 mPa·s to about 1650 mPa·s, from about 650 mPa·s to about 1650 mPa·s, from about 700 mPa·s to about 1650 mPa·s, from about 750 mPa·s to about 1650 mPa·s, from about 250 mPa·s to about 1500 mPa·s, from about 275 mPa·s to about 1500 mPa·s, from about 300 mPa·s to about 1500 mPa·s, from about 325 mPa·s to about 1500 mPa·s, from about 350 mPa·s to about 1500 mPa·s, from about 375 mPa·s to about 1500 mPa·s, from about 400 mPa·s to about 1500 mPa·s, from about 450 mPa·s to about 1500 mPa·s, from about 500 mPa·s to about 1500 mPa·s, from about 550 mPa·s to about 1500 mPa·s, from about 600 mPa·s to about 1500 mPa·s, from about 650 mPa·s to about 1500 mPa·s, from about 700 mPa·s to about 1500 mPa·s, or from about 750 mPa·s to about 1500 mPa·s, including all endpoints and subranges therebetween, at 350° F.

Moreover, the asphalt base composition may exhibit a ring and ball softening point of from about 190° F. to about 320° F. For example, the asphalt base composition may exhibit a ring and ball softening point of from about 190° F. to about 320° F., from about 200° F. to about 320° F., from about 210° F. to about 320° F., from about 220° F. to about 320° F., from about 230° F. to about 320° F., from about 240° F. to about 320° F., from about 250° F. to about 320° F., from about 260° F. to about 320° F., from about 270° F. to about 320° F., from about 190° F. to about 300° F., from about 200° F. to about 300° F., from about 210° F. to about 300° F., from about 220° F. to about 300° F., from about 230° F. to about 300° F., from about 240° F. to about 300° F., from about 250° F. to about 300° F., from about 260° F. to about 300° F., from about 270° F. to about 300° F., from about 190° F. to about 280° F., from about 200° F. to about 280° F., from about 210° F. to about 280° F., from about 220° F. to about 280° F., from about 230° F. to about 280° F., from about 240° F. to about 280° F., from about 250° F. to about 280° F., from about 260° F. to about 280° F., from about 190° F. to about 260° F., from about 200° F. to about 260° F., from about 210° F. to about 260° F., from about 220° F. to about 260° F., from about 230° F. to about 260° F., from about 240° F. to about 260° F., from about 190° F. to about 240° F., from about 200° F. to about 240° F., from about 210° F. to about 240° F., or from about 220° F. to about 240° F., including all endpoints and subranges therebetween. In exemplary aspects, the asphalt base composition does not include a polymer modifier and has a ring and ball softening point of from about 190° F. to about 235° F. In other exemplary aspects, the asphalt base composition includes a polymer modifier and has a ring and ball softening point of from about 190° F. to about 320° F. As used herein, the softening point is measured according to the Ring and Ball Softening Point Test described in ASTM D36.

The asphalt base composition may further have a penetration value of from about 15 dmm to about 40 dmm at 25° C. For example, the asphalt base composition may have a penetration value of from about 15 dmm to about 40 dmm, from about 20 dmm to about 40 dmm, from about 22 dmm to about 40 dmm, from about 24 dmm to about 40 dmm, from about 26 dmm to about 40 dmm, from about 28 dmm to about 40 dmm, from about 30 dmm to about 40 dmm, from about 32 dmm to about 40 dmm, from about 15 dmm to about 35 dmm, from about 20 dmm to about 35 dmm, from about 22 dmm to about 35 dmm, from about 24 dmm to about 35 dmm, from about 26 dmm to about 35 dmm, from about 28 dmm to about 35 dmm, from about 30 dmm to about 35 dmm, from about 15 dmm to about 30 dmm, from about 20 dmm to about 30 dmm, from about 22 dmm to about 30 dmm, from about 24 dmm to about 30 dmm, from about 26 dmm to about 30 dmm, or from about 28 dmm to about 30 dmm, including all endpoints and subranges therebetween, at 25° C. As used herein, the penetration value is measured according to ASTM D5.

As described above, the asphalt base composition is blended with a filler to form the shingle coating composition. The filler is a “hard filler,” which refers to a filler having a Mohs hardness of greater than about 3. For example, the filler may have a Mohs hardness of from about 3.2 to about 9.0, from about 3.5 to about 9.0, from about 3.7 to about 9.0, from about 4.0 to about 9.0, from about 4.5 to about 9.0, from about 5.0 to about 9.0, from about 5.5 to about 9.0, from about 6.0 to about 9.0, from about 6.5 to about 9.0, from about 7.0 to about 9.0, from about 7.5 to about 9.0, from about 3.2 to about 8.0, from about 3.5 to about 8.0, from about 3.7 to about 8.0, from about 4.0 to about 8.0, from about 4.5 to about 8.0, from about 5.0 to about 8.0, from about 5.5 to about 8.0, from about 6.0 to about 8.0, from about 6.5 to about 8.0, from about 7.0 to about 8.0, from about 3.2 to about 7.5, from about 3.5 to about 7.5, from about 3.7 to about 7.5, from about 4.0 to about 7.5, from about 4.5 to about 7.5, from about 5.0 to about 7.5, from about 5.5 to about 7.5, from about 6.0 to about 7.5, from about 6.5 to about 7.5, from about 3.2 to about 7.0, from about 3.5 to about 7.0, from about 3.7 to about 7.0, from about 4.0 to about 7.0, from about 4.5 to about 7.0, from about 5.0 to about 7.0, from about 5.5 to about 7.0, from about 6.0 to about 7.0, from about 6.5 to about 7.0, from about 3.2 to about 6.5, from about 3.5 to about 6.5, from about 3.7 to about 6.5, from about 4.0 to about 6.5, from about 4.5 to about 6.5, from about 5.0 to about 6.5, or from about 5.5 to about 6.5, including all endpoints and subranges therebetween. In exemplary aspects, the filler has a Mohs hardness of from about 3.5 to about 4.0, from about 4.5 to about 5.5, from about 6 to about 7, or from about 6.5 to about 7.5.

The filler may include particles comprising any variety of ground inorganic particulate matter, such as, for example, dolomite, silica, granite, fly ash, wollastonite, recycled asphalt shingles, reclaimed filler from asphalt shingles, and combinations thereof. As used herein, “reclaimed filler from asphalt shingles” is filler or material that was used in an asphalt-based roofing shingle that was installed on a roof and reclaimed (e.g., a tear-off shingle) and recovered. Such filler may have been employed as a granule on the shingle, as back dust, or otherwise incorporated into one or more of the layers of the shingle. As a result of the use of the filler in a roofing shingle, the reclaimed filler has a greater Mohs hardness than virgin filler material.

The filler material may comprise particles having an average (median) particle size in the range of 0.3 microns to 200 microns, including an average particle size range of 1 micron to 180 microns, 5 microns to 175 microns, 15 microns to 150 microns, 25 microns to 125 microns, 30 microns to 115 microns, 35 microns to 100 microns, 40 microns to 85 microns, and 45 microns to 60 microns, including all endpoints and subranges therebetween), as measured in accordance with ASTM D5603-01.

The shingle coating composition includes greater than or equal to about 5 wt. % of the filler. For example, the shingle coating composition may include from about 5 wt. % to about 80 wt. %, from about 5 wt. % to about 75 wt. %, from about 5 wt. % to about 70 wt. %, from about 10 wt. % to about 80 wt. %, from about 10 wt. % to about 75 wt. %, from about 10 wt. % to about 70 wt. %, from about 20 wt. % to about 80 wt. %, from about 20 wt. % to about 75 wt. %, from about 20 wt. % to about 70 wt. %, from about 30 wt. % to about 80 wt. %, from about 30 wt. % to about 75 wt. %, from about 30 wt. % to about 70 wt. %, from about 40 wt. % to about 80 wt. %, from about 40 wt. % to about 75 wt. %, from about 40 wt. % to about 70 wt. %, from about 50 wt. % to about 80 wt. %, from about 50 wt. % to about 75 wt. %, from about 50 wt. % to about 70 wt. %, from about 60 wt. % to about 80 wt. %, from about 60 wt. % to about 75 wt. %, from about 60 wt. % to about 70 wt. %, from about 65 wt. % to about 80 wt. %, from about 65 wt. % to about 75 wt. %, or from about 65 wt. % to about 70 wt. % of the filler, based on a total amount of solids in the shingle coating composition, including all endpoints and subranges therebetween. In exemplary aspects, the shingle coating composition includes from about 30 wt. % to about 40 wt. % of the asphalt base composition and from about 60 wt. % to about 70 wt. % of the filler.

Once filled, the shingle coating composition exhibits a viscosity of from about 250 mPa·s to about 2,000 mPa·s at 350° F. and as measured in accordance with ASTM D4402. For example, the shingle coating composition may have any of the viscosities set forth hereinabove with respect to the asphalt base composition.

Moreover, the shingle coating composition may exhibit a ring and ball softening point of from about 190° F. to about 320° F. For example, the shingle coating composition may exhibit a ring and ball softening point of from about 190° F. to about 320° F., from about 200° F. to about 320° F., from about 210° F. to about 320° F., from about 220° F. to about 320° F., from about 230° F. to about 320° F., from about 240° F. to about 320° F., from about 250° F. to about 320° F., from about 260° F. to about 320° F., from about 270° F. to about 320° F., from about 190° F. to about 300° F., from about 200° F. to about 300° F., from about 210° F. to about 300° F., from about 220° F. to about 300° F., from about 230° F. to about 300° F., from about 240° F. to about 300° F., from about 250° F. to about 300° F., from about 260° F. to about 300° F., from about 270° F. to about 300° F., from about 190° F. to about 280° F., from about 200° F. to about 280° F., from about 210° F. to about 280° F., from about 220° F. to about 280° F., from about 230° F. to about 280° F., from about 240° F. to about 280° F., from about 250° F. to about 280° F., from about 260° F. to about 280° F., from about 190° F. to about 260° F., from about 200° F. to about 260° F., from about 210° F. to about 260° F., from about 220° F. to about 260° F., from about 230° F. to about 260° F., from about 240° F. to about 260° F., from about 190° F. to about 240° F., from about 200° F. to about 240° F., from about 210° F. to about 240° F., or from about 220° F. to about 240° F., including all endpoints and subranges therebetween. In exemplary aspects, the shingle coating composition does not include a polymer modifier and has a ring and ball softening point of from about 190° F. to about 235° F. In other exemplary aspects, the shingle coating composition includes a polymer modifier and has a ring and ball softening point of from about 190° F. to about 320° F.

The shingle coating composition may further have a penetration value of from about 15 dmm to about 40 dmm at 25° C. For example, the shingle coating composition may have a penetration value of from about 15 dmm to about 40 dmm, from about 20 dmm to about 40 dmm, from about 22 dmm to about 40 dmm, from about 24 dmm to about 40 dmm, from about 26 dmm to about 40 dmm, from about 28 dmm to about 40 dmm, from about 30 dmm to about 40 dmm, from about 32 dmm to about 40 dmm, from about 15 dmm to about 35 dmm, from about 20 dmm to about 35 dmm, from about 22 dmm to about 35 dmm, from about 24 dmm to about 35 dmm, from about 26 dmm to about 35 dmm, from about 28 dmm to about 35 dmm, from about 30 dmm to about 35 dmm, from about 15 dmm to about 30 dmm, from about 20 dmm to about 30 dmm, from about 22 dmm to about 30 dmm, from about 24 dmm to about 30 dmm, from about 26 dmm to about 30 dmm, or from about 28 dmm to about 30 dmm, including all endpoints and subranges therebetween, at 25° C.

### Roofing Materials

The shingle coating composition disclosed herein may be used as a coating on substrates for use in the manufacture of shingles and other roofing products, such as roofing underlayments, membranes, roll roofing, and the like. Asphalt-based roofing products are installed on the roofs of buildings to provide protection from the elements and to give the roof an aesthetically pleasing look. As such, the shingle coating composition may be applied to at least a portion of a substrate. The substrate can be any type known for use in asphalt-based roofing materials, such as a web, scrim or felt of fibrous materials such as mineral fibers, fiberglass, cellulose fibers, rag fibers, mixtures of mineral and synthetic fibers, or the like. Combinations of materials can also be used in the substrate. In aspects, the substrate is a nonwoven web of glass fibers. The substrate may be any conventional substrate used in asphalt shingles, roll roofing, low-slope membranes, and the like.

A conventional roofing shingle is typically constructed of a substrate, an asphalt coating composition that saturates the substrate and forms a layer of asphalt coating on a top surface and a bottom surface of the substrate, a decorative/protective layer of granules applied to the asphalt coating on the top surface of the substrate, and optionally, a layer of sand or other parting agent applied to the asphalt coating on the bottom surface of the substrate. The asphalt coatings are generally formed from a layer of hot, melted asphalt composition (e.g., the shingle coating composition described herein) applied to the substrate. The asphalt coating can be applied to the substrate in any suitable manner. For example, the substrate can be submerged in the shingle coating composition or the shingle coating composition can be rolled on, sprayed on, or applied to the substrate by other means.

Although the use of a hard filler is generally associated with a reduced shingle tear strength, it was surprisingly found that the use of recycled rubber, such as GTR, and a wax in the asphalt base composition blended with the hard filler was effective to reduce crack initiation and propagation during tear testing, leading to improved tear resistance in shingles including the shingle coating composition. The improved tear resistance, in turn, may lead to higher filler loadings, thinner substrates, and improved impact resistance of the shingles. Moreover, the use of reclaimed materials (e.g., GTR and fillers such as recycled asphalt shingles or fillers reclaimed from asphalt shingles) can reduce the carbon footprint of the shingles.

In aspects, roofing shingles including the asphalt coating composition described herein exhibit a cross-direction (CD) tear resistance of at least 1,600 grams-force as measured according to ASTM D1922, where 1 Newton (N) is 101.97 grams-force. For example, the roofing shingle may exhibit a tear resistance of at least about 1,600 grams-force, at least about 1,650 grams-force, at least about 1,700 grams-force, at least about 1,750 grams-force, at least about 1,800 grams-force, at least about 1,850 grams-force, or even at least about 1,900 grams-force. The roofing shingle may exhibit an increase of at least 10% as compared to an otherwise identical shingle including a standard oxidized asphalt coating including standard filler. For example, the roofing shingle may exhibit an increase of from about 10% to about 50%, from about 15% to about 50%, from about 20% to about 50%, from about 25% to about 50%, from about 30% to about 50%, from about 35% to about 50%, from about 40% to about 50%, or from about 45% to about 50%, including all endpoints and subranges therebetween.

Roofing shingles prepared with the asphalt coating composition may be classified as a Class 3 or Class 4 roofing shingle. Various aspects meet the roofing shingle standards set forth in ASTM D3462. For example, shingles prepared with the asphalt coating composition exhibit a softening point of from 190° F. to 235° F. (190° F. to 320° F. for polymer-modified asphalt), a penetration at 77° F. of 15 to 25 decimillimeter (dmm), and a tear resistance above about 1700 g-f.

### EXAMPLES

### Example 1

In order to evaluate the impact of recycled rubber on the properties of an asphalt base composition, various compositions (Comp. B-F) were prepared using different amounts and particle sizes of GTR in a non-oxidized asphalt (PG 64-22). Composition F included SBS as a polymer modifier in addition to the GTR and non-oxidized asphalt. A comparative formulation (Comp. A) using an oxidized asphalt was also evaluated. For each of the formulations, softening point, penetration, and viscosity were measured. Viscosity was measured according to ASTM D4402. The formulations and results are presented in Table 1 below.

TABLE 1

| | GTR | | | | | | |
|---|---|---|---|---|---|---|---|
| | Size | GTR | | Softening | Penetration | Viscosity | |
| | (Mesh) | Load | | Point | @ 77° F. | @ 350° F. | |
| Comp. A | 40-80 | 6 | wt. % | 245° F. | 14 dmm | 8983.7 | cps |
| Comp. B | 80-100 | 14 | wt. % | 178° F. | 32 dmm | 1292.7 | cps |
| Comp. C | 40-80 | 6 | wt. % | 165° F. | 34 dmm | 169 | cps |
| Comp. D | 40-80 | 10 | wt. % | 171° F. | 33 dmm | 330 | cps |
| Comp. E | 40-80 | 14 | wt. % | 181° F. | 32 dmm | 776.7 | cps |
| Comp. F | 40-80 | 14 | wt. % | 204° F. | 25 dmm | 2845 | cps |
| (+3 wt. % | | | | | | | |
| SBS) | | | | | | | |

As shown in Table 1, the softening point and viscosity increase with increased loading of GTR, while the penetration decreases with increased loading of GTR. The use of non-oxidized asphalt kept the viscosity below the maximum acceptable viscosity. However, the softening point for each of Comp. B-E was below the minimum softening point required for use in an asphalt shingle coating. Notably, the incorporation of SBS (Comp. F) was effective to increase the softening point while not adversely increasing the penetration or viscosity.

Because Comp. B-E were out of specification, the compositions were further modified to include a wax. In particular, a Fisher-Tropsch wax (SASOBIT wax available from Sasol) was added to the asphalt base composition (a non-oxidized PG 64-22 asphalt plus GTR) and the softening point, penetration, and viscosity were measured. The compositions and results are provided in Table 2 below.

TABLE 2

| | Wax | GTR | | Softening | Penetration | | Viscosity | |
|---|---|---|---|---|---|---|---|---|
| | Load | Load | | Point | @ 77° F. | | @ 350° F. | |
| Sample 1 | 4 wt. % | 5 | wt. % | 195° F. | 28.5 | dmm | 151.5 | cps |
| Sample 2 | 4 wt. % | 10 | wt. % | 197° F. | 25 | dmm | 492.5 | cps |
| Sample 3 | 4 wt. % | 15 | wt. % | 200° F. | 29 | dmm | 775 | cps |
| Comp. G | 4 wt. % | 20 | wt. % | 215° F. | 21.7 | dmm | 4080 | cps |

Sample 1, which included 5 wt. % GTR and 4 wt. % wax, had a viscosity that was too low, although it was theorized that processing parameters could be modified to enable the use of this composition in shingles. Samples 2 and 3 each had suitable softening points, penetration values, and viscosities. Comp. G had a viscosity that was too high to be processed, although the softening point was good.

The data in Tables 1-2 demonstrates general trends that are observed as a result of the inclusion of various components into the asphalt base composition, and further demonstrate the impact of including wax and GTR in the asphalt base composition. Moreover, the data in Table 2 demonstrates that GTR can be incorporated in amounts of from greater than 5 wt. % to less than 20 wt. % while achieving suitable softening points, penetration values, and viscosities. Moreover, based on Comp. G, it was believed that higher levels of wax may be sufficient to enable greater GTR loadings.

Next, SBS was added to the asphalt base compositions to determine its impact, based partially on Comp. F in Table 1. In particular, 3 wt. % SBS was added to PG 64-22 asphalt including 4 wt. % SASOBIT wax and a varying amount of GTR to provide Samples 4-5 and Comp. H and the softening point, penetration, and viscosity were measured. The results are presented in Table 3 below.

TABLE 3

| | GTR | | Softening | | Penetration | | Viscosity | |
|---|---|---|---|---|---|---|---|---|
| | Load | | Point | | @ 77° F. | | @ 350° F. | |
| Sample 4 | 5 | wt. % | 210° | F. | 23.9 | dmm | 610.8 | cps |
| Sample 5 | 12 | wt. % | 204° | F. | 25 | dmm | 2,115 | cps |
| Comp. H | 17 | wt. % | 228.5° | F. | 21.7 | dmm | 16,653 | cps |

As shown in Table 3, the blend that included 3 wt. % SBS, 4 wt. % wax, and either 5 wt. % GTR, and 12 wt. % GTR (Samples 4 and 5) exhibited acceptable softening point, penetration, and viscosity, while the blend that included 17 wt. % GTR (Comp. H) had a viscosity that was too high. By comparing Sample 4 with Sample 1, the impact of the SBS on the softening point, penetration, and viscosity can be seen. As such, it was observed that the inclusion of a polymer modifier, such as SBS, reduced the amount of GTR that could be added to the asphalt base composition while keeping the penetration and viscosity within acceptable ranges.

### Example 2

The use of the above asphalt base compositions to provide a filled asphalt shingle coating was also evaluated. In particular, the asphalt base compositions including a non-oxidized asphalt (PG 64-22), 2 wt. % SASOBIT wax, and a varying amount of GTR were prepared as Comp. I-K. To prepare Comp. L-N, the compositions of Comp. I-K were blended with 68 wt. % of a standard filler. The softening point was measured for each of Comp. I-N. The results are presented in Table 4 below.

TABLE 4

| | |
|---|---|
| GTR Load | Softening Point |

Unfilled

| | | | |
|---|---|---|---|
| Comp. I | 6 | wt. % | 165° F. |
| Comp. J | 10 | wt. % | 171° F. |
| Comp. K | 14 | wt. % | 181° F. |

Filled

| | | | |
|---|---|---|---|
| Comp. L | 6 | wt. % | 189° F. |
| Comp. M | 10 | wt. % | 210° F. |
| Comp. N | 14 | wt. % | 218° F. |

The inclusion of the filler was effective to increase the softening point by a greater amount than the GTR alone, with even Comp. L being close to the minimum softening point needed for use in a shingle.

### Example 3

Shingle prototypes were prepared using a variety of coatings and tear resistance was evaluated. In particular, comparative samples (Comp. O and Comp. P) utilized a standard oxidized asphalt coating composition while comparative samples (Comp. Q and Comp. R) were prepared using standard filler blended with a non-oxidized asphalt including GTR and wax, with or without SBS. Samples 6 and 7 included the asphalt coating compositions of various aspects disclosed herein. The non-oxidized asphalt was PG 64-22. The wax was SASOBIT wax. The GTR had a mesh size of 40-90 mesh. The total filler loading for all blends was 65 wt. %. When recycled filler was included, standard filler (e.g., CaCO₃) was replaced. The amounts of asphalt, GTR, wax, and SBS are reported as a wt. % based on the total weight of solids in the asphalt base composition. The amounts of filler are reported as a wt. % based on the total weight of solids in the shingle coating composition. The formulations and results are provided in Table 5 below.

TABLE 5

| | | | | | |
|---|---|---|---|---|---|
| Comp. O | Comp. P | Comp. Q | Comp. R | Sample 6 | Sample 7 |

Unfilled Asphalt Compositions

| | | | | | | | | | | | | |
|---|---|---|---|---|---|---|---|---|---|---|---|---|
| Oxidized Asphalt | 100 | wt. % | 100 | wt. % | 0 | wt. % | 0 | wt. % | 0 | wt. % | 0 | wt. % |
| PG 64-22 Asphalt | 0 | wt. % | 0 | wt. % | 81 | wt. % | 81 | wt. % | 81 | wt. % | 81 | wt. % |
| GTR | 0 | wt. % | 0 | wt. % | 15 | wt. % | 12 | wt. % | 15 | wt. % | 12 | wt. % |
| Wax | 0 | wt. % | 0 | wt. % | 4 | wt. % | 4 | wt. % | 4 | wt. % | 4 | wt. % |
| SBS | 0 | wt. % | 0 | wt. % | 0 | wt. % | 3 | wt. % | 0 | wt. % | 3 | wt. % |

Filler

| | | | | | | | | | | | | |
|---|---|---|---|---|---|---|---|---|---|---|---|---|
| Standard filler | 65 | wt. % | 58.5 | wt. % | 65 | wt. % | 65 | wt. % | 58.5 | wt. % | 58.5 | wt. % |
| Recycled filler | 0 | wt. % | 6.5 | wt. % | 0 | wt. % | 0 | wt. % | 6.5 | wt. % | 6.5 | wt. % |

CD Tear

| | | | | | | | | | | | | |
|---|---|---|---|---|---|---|---|---|---|---|---|---|
| As-is | 1201 | g-f | 1128 | g-f | 1684 | g-f | 1449 | g-f | 1631 | g-f | 1538 | g-f |

Cross-direction (CD) tear resistance was measured according to ASTM D1922. CD tear was improved for all samples as compared to the comparatives prepared using the oxidized asphalt coating composition (Comp. O and Comp. P). Looking at Comp. O and Comp. P, the CD tear dramatically drops when recycled filler is included in the shingle coating. However, although the use of recycled filler led to a very slight decrease in as-is CD tear for Sample 6 as compared to Comp. Q, the use of the recycled filler in Sample 7 led to a significant increase in as-is CD tear over Comp. R.

Moreover, the CD tear values reported in Table 5 suggest that actual shingles, as compared to the prototypes that were utilized for testing, would exhibit a CD tear of greater than 1600 grams-f. In other words, the results are based on testing shinglet samples in a lab and not full shingle coupons. Thus, the results are for purposes of comparison only and not commensurate with standard shingle properties.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the devices and systems disclosed. It is sought, therefore, to cover all such changes and modifications as fall within the spirit and scope of the general inventive concepts, as described and/or claimed herein, and any equivalents thereof.

What is claimed is:

1. A roofing shingle comprising:
a base material; and
a shingle coating composition applied to at least one side of the base material, said shingle coating composition comprising:
an asphalt base composition comprising:
non-oxidized or partially oxidized asphalt;
optionally, at least one polymer additive;
from 6 wt. % to less than 20 wt. % ground tire rubber, based on a total weight of the asphalt base composition; and
wax, in an amount up to about 6 wt. %, based on a total weight of the asphalt base composition; and
greater than or equal to about 5 wt. % of a filler, based on a total weight of the shingle coating composition, the filler having a Mohs hardness of greater than about 3.

2. The roofing shingle according to claim 1, wherein the filler is selected from the group consisting of dolomite, silica, granite, fly ash, wollastonite, recycled asphalt shingles, reclaimed filler from asphalt shingles, and combinations thereof.

3. The roofing shingle according to claim 1, wherein the wax is a Fisher-Tropsch wax having a crystallinity of from about 50 to about 90%.

4. The roofing shingle according to claim 1, wherein the at least one polymer additive comprises a linear copolymer, a radial copolymer, or a blend thereof.

5. The roofing shingle according to claim 1, wherein the at least one polymer additive is selected from the group consisting of atactic polypropylene (APP), isotactic polypropylene (IPP), styrene-butadiene rubber (SBS), polychloroprene; polynorbornene; chloroprene rubber (CR), natural and reclaimed rubbers, butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), vinylacetate/polyethylene (EVA), ethylene-methylacrylate copolymers (EMA), copolymers of olefins and unsaturated carboxylic esters, polyolefinic copolymers, polyolefins, copolymers of ethylene and esters of acrylic acid or methacrylic acid or maleic anhydride, copolymers and terpolymers of ethylene and glycidyl methacrylate, ethylene/propylene copolymers, and rubber.

6. The roofing shingle according to claim 1, wherein the at least one polymer additive comprises SBS.

7. The roofing shingle according to claim 1, wherein the at least one polymer additive is present in the asphalt base composition in an amount of from about 1 wt. % to about 3 wt. %.

8. The roofing shingle according to claim 1, wherein the wax is present in the asphalt base composition in an amount of from about 2 wt. % to about 6 wt. %.

9. The roofing shingle according to claim 1, wherein the roofing shingle exhibits a tear resistance of at least about 1600 grams-force.

10. The roofing shingle according to claim 1, wherein the asphalt base composition exhibits a ring and ball softening point of from about 190° F. to about 320° F.

11. The roofing shingle according to claim 1, wherein the asphalt base composition exhibits a viscosity of from about 250 mPa·s to about 2500 mPa·s at 350° F. when measured according to ASTM D4402.

12. A shingle coating composition comprising:
an asphalt base composition comprising:
non-oxidized or partially oxidized asphalt;
at least one polymer additive;
from 5 wt. % to less than 12 wt. % ground tire rubber based on a total weight of the shingle coating composition; and
wax, in an amount of up to about 6 wt. % based on a total weight of the shingle coating composition; and
greater than or equal to about 5 wt. % of a filler having a Mohs hardness of greater than about 3, based on a total weight of the shingle coating composition,
wherein the shingle coating composition exhibits a penetration value at 25° C. of at least about 15 dmm and a ring and ball softening point of from about 190° F. to about 320° F.

13. The shingle coating composition according to claim 12, wherein the filler is selected from the group consisting of dolomite, silica, granite, fly ash, wollastonite, recycled asphalt shingles, reclaimed filler from asphalt shingles, and combinations thereof.

14. The shingle coating composition according to claim 12, wherein the wax is a Fisher-Tropsch wax having a crystallinity of from about 50 to about 90%.

15. The shingle coating composition according to claim 12, wherein the at least one polymer additive comprises a linear copolymer, a radial copolymer, or a blend thereof.

16. The shingle coating composition according to claim 12, wherein the at least one polymer additive is styrene-butadiene rubber (SBS).

17. The shingle coating composition according to claim 12, wherein the at least one polymer additive is present in the asphalt base composition in an amount of from about 1 wt. % to about 3 wt. %.

18. The shingle coating composition according to claim 12, wherein the wax is present in the asphalt base composition in an amount of from about 2 wt. % to about 6 wt. %.

19. A shingle coating composition comprising:
an asphalt base composition comprising:
non-oxidized or partially oxidized asphalt;
from 6 wt. % to less than 20 wt. % ground tire rubber based on a total weight of the asphalt base composition; and
wax, in an amount of up to about 6 wt. %, based on a total weight of the asphalt base composition; and
greater than or equal to about 5 wt. % of a filler having a Mohs hardness of greater than about 3, based on a total weight of the shingle coating composition,
wherein the shingle coating composition exhibits penetration value at 25° C. of at least about 15 dmm and a ring and ball softening point of from about 190° F. to about 235° F.

20. The shingle coating composition according to claim 19, wherein the wax is a Fisher-Tropsch wax having a crystallinity of from about 50 to about 90%.
